(19) United States
(12) Patent Application Publication
(10) Pub. No.: US 2026/0341121 A1
(43) Pub. Date: Oct. 29, 2026

(54) MANAGING DEVICE, PROGRAM, AND MANAGING METHOD

(71) Applicant: SEGA SAMMY HOLDINGS INC., Shinagawa-ku, Tokyo (JP)

(72) Inventors: Ryuta MATSUDA, Tokyo (JP); Osamu KATAYAMA, Tokyo (JP); Makoto KANEKO, Tokyo (JP); Junichi NOZAWA, Tokyo (JP); Naoki TAKADA, Tokyo (JP); Yuji SHIMADA, Tokyo (JP)

(21) Appl. No.: 19/122,261

(22) PCT Filed: Oct. 21, 2022
(86) PCT No.: PCT/JP2022/039347

§ 371 Date: May 28, 2025

(51) Int. Cl. G07F 17/32; G06Q 50/34; G07C 9/38

(52) U.S. Cl. CPC G07F 17/3269; G06Q 50/34; G07C 9/38; G07F 17/323; G07C 2209/08

(57) ABSTRACT

Provided are a managing device and the like for an amusement facility that are capable of strictly managing users who have entered the amusement facility. A managing server that manages entry into an amusement facility includes: a clocking unit that measures a duration of stay of a user who has entered the amusement facility; and a notification unit that notifies the user, before the duration of stay reaches a time limit, that games that are played by use of amusement machines in the amusement facility are about to be restricted when the duration of stay exceeds the time limit.

### FIELD

The present invention relates to a managing device, a program, and a managing method for managing matters such as entries into an amusement facility.

### BACKGROUND

Some amusement facilities, such as casino facilities, are known to collect an entry fee and a fee based on a duration of stay. For example, Patent Literature 1discloses a system that collects an entry fee at the time of entry into a casino facility and an additional entry fee after a certain period (for example, 24 hours) from entry.

### CITATION LIST

### Patent Literature

Patent Literature 1: Japanese U.S. Pat. No. 6,904,492

### SUMMARY

Meanwhile, while a casino facility tends to be a hotbed of fraud (for example, money laundering) and thus needs to strictly manage users who have entered the facility, a system that implements such management has not been available so far.

The present invention has been made in view of the above situation, and is directed to providing a managing device and the like for an amusement facility capable of strictly managing users who have entered the amusement facility.

A managing device according to one aspect of the present invention is a managing device configured to manage entry into an amusement facility, the managing device including: a clocking unit configured to measure a duration of stay of a user who has entered the amusement facility; and a notification unit configured to notify the user, before the duration of stay reaches a time limit, that a game played by use of an amusement machine in the amusement facility is about to be restricted when the duration of stay exceeds the time limit.

A program according to one aspect of the present invention causes a computer that manages entry into an amusement facility to execute the steps of: measuring a duration of stay of a user who has entered the amusement facility; and notifying the user, before the duration of stay reaches a time limit, that a game played by use of an amusement machine in the amusement facility is about to be restricted when the duration of stay exceeds the time limit.

A managing method according to one aspect of the present invention is a managing method for an amusement facility, the amusement facility being executed by a computer, the managing method including the steps of: measuring a duration of stay of a user who has entered the amusement facility; and notifying the user, before the duration of stay reaches a time limit, that a game played by use of an amusement machine in the amusement facility is about to be restricted when the duration of stay exceeds the time limit.

### Advantageous Effects of Invention

According to the present invention, users who have entered an amusement facility can be strictly managed.

### BRIEF DESCRIPTION OF DRAWINGS

FIG. 1 is a block diagram illustrating the configuration of a facility management system according to the present embodiment.

FIG. 2 is a diagram exemplarily illustrating contents registered in an entry database and a membership database.

FIG. 3A is a diagram illustrating a sequence of operations that are executed when a member user enters a casino facility.

FIG. 3B is a diagram illustrating a sequence of operations that are executed when a non-member user enters a casino facility.

FIG. 4 is a block diagram illustrating the functional configuration implemented by a managing server.

FIG. 5 is a sequence diagram illustrating a sequence of operations in a facility management system 1 that solve a first problem.

FIG. 6 is a diagram illustrating a sequence of operations that are executed when a non-updated user enters a casino facility.

FIG. 7 is a sequence diagram illustrating a sequence of operations in the facility management system that solve a second problem.

FIG. 8 is a sequence diagram illustrating a first example of operations in the facility management system that solve a third problem.

FIG. 9 is a sequence diagram illustrating a second example of operations in the facility management system that solve the third problem.

FIG. 10 is a sequence diagram illustrating a third example of operations in the facility management system that solve the third problem.

FIG. 11 is a sequence diagram illustrating a fourth example of operations in the facility management system that solve the third problem.

FIG. 12 is a block diagram illustrating the configuration of the main part of a mobile terminal.

FIG. 13 is a sequence diagram illustrating a fifth example of operations in the facility management system that solve the third problem.

FIG. 14 is a sequence diagram illustrating a sixth example of operations in the facility management system that solve the third problem.

### DESCRIPTION OF EMBODIMENTS

Preferred embodiments of the present invention are described herein with reference to the accompanying drawings. In each of the drawings, elements with the same symbol have the same or similar configuration.

### A. THE Present Embodiment

First, the schematic configuration of a facility management system according to the present embodiment is be explained, and problems concerning casino facilities at present and solutions to the problems are then described.

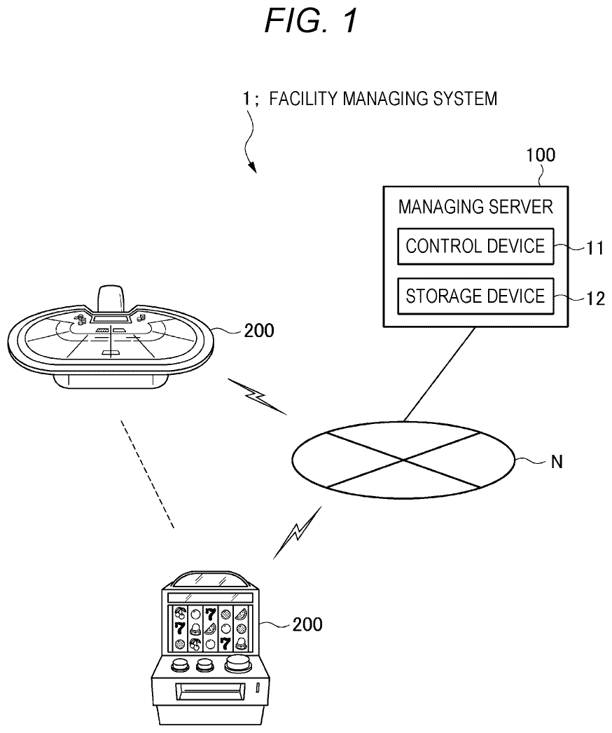

FIG. 1 is a block diagram illustrating a configuration of a facility management system 1 according to the present embodiment.

As illustrated in FIG. 1, the facility management system 1 is a system that manages entries into and a duration of stay in a casino facility, and is configured by including a managing server 100 and various amusement machines 200 installed in the casino facility.

The managing server 100 and the amusement machines 200 are connected via a communication network N. Each of the amusement machines 200 controls the state of games under the management by the managing server 100. The term “amusement machine” as used herein refers to any device that enables the act of playing games (game play) in the casino facility, and may be, for example, a slot machine, or a game table on which cards, a roulette, dices, or the like are used. The number of amusement machines is not limited.

The communication network N includes a communication network that enables information to be sent and received mutually between the managing server 100 and each of the amusement machines 200. The communication network N may be, for example, the Internet, a local area network (LAN), a dedicated line, a telephone line, a corporate network, a mobile communication network, Bluetooth (registered trademark), WiFi (Wireless Fidelity), or another communication line, or a combination of any of the foregoing, and it does not matter whether the communication network N is wired or wireless.

### <First Problem and Solution Thereto>

In overseas casinos, there are users who enter for the purpose of doing deals with other users, not for the purpose of playing games in casino facilities. In order to prevent peace and order in casino facilities from being impaired, it is necessary to strictly manage the entry of users not for the purpose of playing games.

In light of these circumstances, the present embodiment pertains to the construction of a mechanism that, in principle, makes it an obligation for users to create membership cards and thus prohibits users from playing games without membership cards.

At the entry gate, each user is asked to present an identity verification document, such as a My Number Card or a passport, so that it is confirmed whether the user is a user who has a membership card (i.e., a user who has already been registered as a member). A user who does not have a membership card is guided to create a membership card.

A user who does not create a membership card for a certain period of time although having been guided to do so, or a user who has created a membership card but do not play any game in a casino facility for a certain period of time, is made subject to monitoring by concerned personnel (such as staff) of the casino facility.

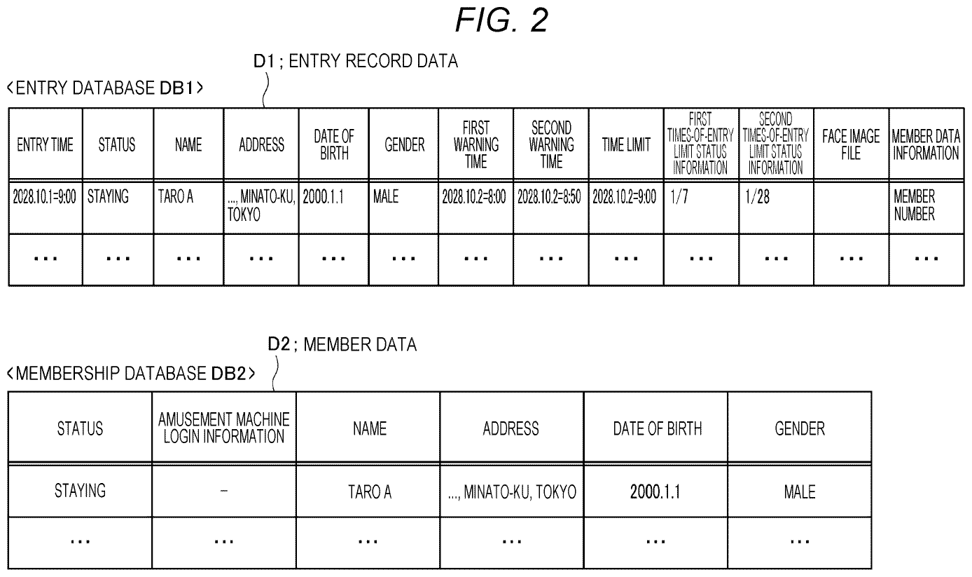

FIG. 2 exemplarily illustrates contents registered in an entry database DB1 and a membership database DB2, which are retained by the managing server 100.

In the entry database DB1, a plurality of pieces of entry record data D1 about users entering the casino facility are registered.

In the entry record data D1, for example, the entry time, status, name, address, date of birth, and gender, as well as warning times (first warning time and second warning time), the time limit, times-of-entry limit (first times-of-entry limit status information and second times-of-entry limit status information), face image file, member data information, are registered with respect to each user.

The “time limit” is date and time at which the maximum duration of time (e. g., 24 hours after entry) for which a user is allowed to stay in the facility without paying an additional entry fee; and the “warning time” is date and time before the time limit at which a corresponding user is notified in advance that the time limit is approaching. In the present embodiment, two such warning times, which are the first warning time (an hour before the time limit) and the second warning time (10 minutes before the time limit), are set. However, any number of warning times may be set.

The “times-of-entry limit” indicates the number of times, during a certain period, a user can enter the casino facility and the number of times the user has entered the casino facility so far. In the present embodiment, the first times-of-entry limit status information represents the number of times a user has entered the facility so far, which is limited to three, for the past seven days. The second times-of-entry limit status information represents the number of times a user has entered the facility so far, which is limited to ten, for the past 28 days.

The time limit, warning times, and times-of-entry limits can be set at any dates and times or numbers according to various laws and regulations related to casino facilities (e.g., the Act on Development of Specified Integrated Resort Districts).

At the same time, a plurality of pieces of member data on registered users (i.e., users who have already created membership cards) have been registered in the membership database DB2.

The member data D2 has, for example, the status, amusement machine login information, name, address, date of birth, and gender registered with respect to each user who has a membership card. For convenience, a user who has already created a membership card is referred to as a member user and a user who has not created a membership card is referred to as a non-member user.

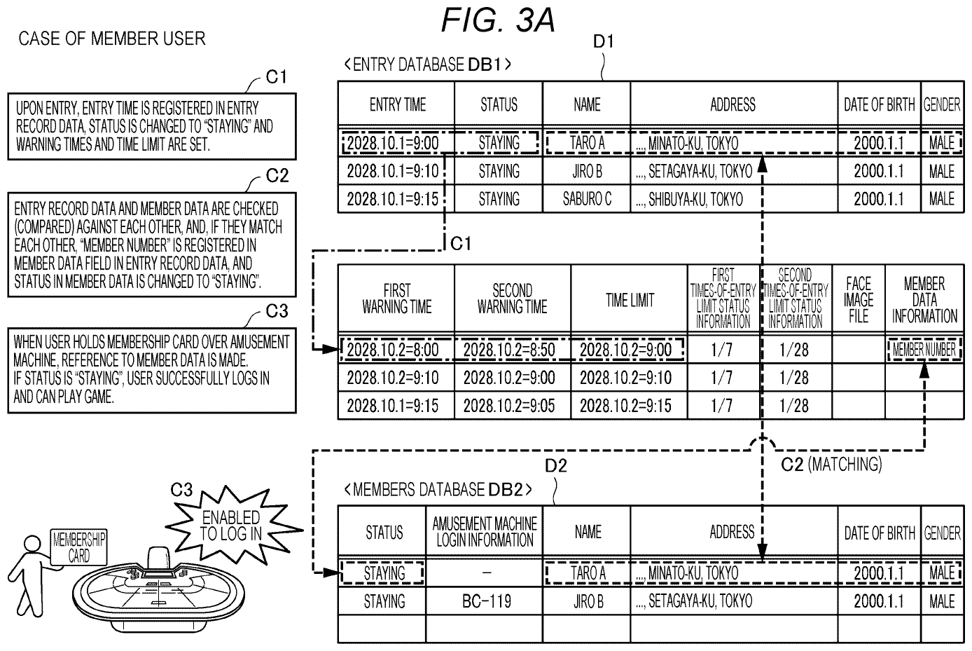

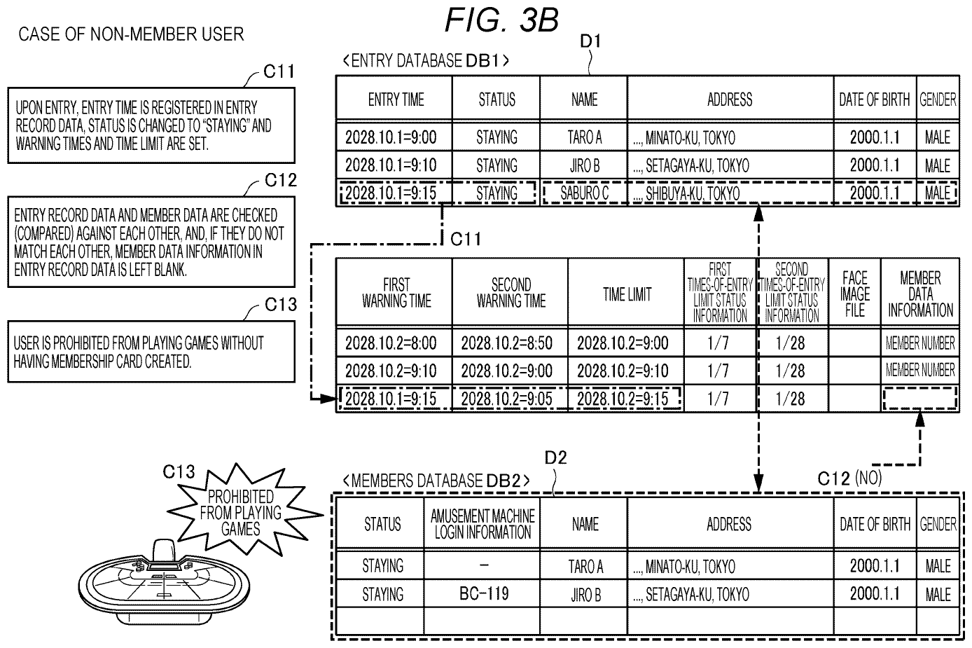

FIGS. 3A and 3B illustrate sequences of operations to be executed when a member user enters the casino facility and when a non-member user enters the casino facility, respectively.

### <The Case of a Member User>

When a member user presents an identity verification document at the entry gate, the managing server 100 generates a piece of entry record data D1 for the user based on the presented identity verification document of the user and registers the data in the entry database DB1. Specifically, the managing server 100 registers the piece of entry record data D1, which includes the entry time, warning times, time limit, times-of-entry limits, and status (“Staying”), along with the name, address, date of birth, and gender (hereafter, basic user information) obtained from the identity verification document (C1).

The managing server 100 then checks (compares) the piece of entry record data D1 and the member data D2 against each other with reference to the entry database DB1 and the membership database DB2. Upon confirming that these data match each other (i.e., successful verification), the managing server 100 registers the “member number” (member identifier) read out from the member data in the member data information in the piece of entry record data D1, and registers “Staying” in the status of the member data D2 (C2).

Thereafter, when the member user holds the membership card thereof over an amusement machine (e.g., a game table) 200 in the casino facility, the amusement machine 200 makes an inquiry to the managing server 100 about the member data. The managing server 100, with reference to the membership database DB2, check the status of the user in question. As illustrated in FIG. 3A, if the status in the member data D2 corresponding to the user is “Staying”, the user is allowed to log in to the amusement machine 200.

This allows the member user to play games on the amusement machine 200 (C3).

### <The Case of a Non-member User>

When a non-member user presents an identity verification document at the entry gate, the managing server 100 generates a piece of entry record data D1 for the user based on the presented identity verification document of the user and registers the piece of data in the entry database DB1. Specifically, the managing server 100 registers the piece of entry record data D1, which includes the entry time, warning times, time limit, times-of-entry limit, and status (“Staying”), along with the name, address, date of birth, and gender (hereafter, basic user information) obtained from the identity verification document (C11).

The managing server 100 then checks (compares) the piece of entry record data D1 and the member data D2 against each other with reference to the entry database DB1 and the membership database DB2. In this case, the user is a non-member user, and data on this non-member user has not been registered in the membership database DB2. Therefore, the managing server 100 determines that there is no data (i.e., unsuccessful verification), and registers nothing in the member data information in the entry record data D1 (C12).

As illustrated in FIG. 3B, the managing server 100 performs control so as not to allow a non-member user to play games (i.e., prohibit a non-member user from playing games) on the amusement machine 200 without having a membership card issued for the user (C13).

The configuration of the managing server 100 is described below with reference to the drawings.

### <Managing Server>

The managing server (managing device) 100 is a general-purpose computer and may consist of a single computer or multiple computers distributed over a communication network. As illustrated in FIG. 1, the managing server 100 includes a control device 11 and a storage device 12. The control device 11 includes hardware elements such as a central processing unit (CPU), memories such as a read-only memory (ROM) and a random-access memory (RAM), an input interface, an output interface, a communication interface, and a bus connecting the above elements with one another. The control device 11 causes the CPU to execute programs stored in the ROM or the like, thereby implementing functions of, for example, managing entry into and stay at the casino facility and managing games played with the use of each of the amusement machines 200 in the casino facility. The storage device 12 is a hard disk drive or similar device that stores various programs and data.

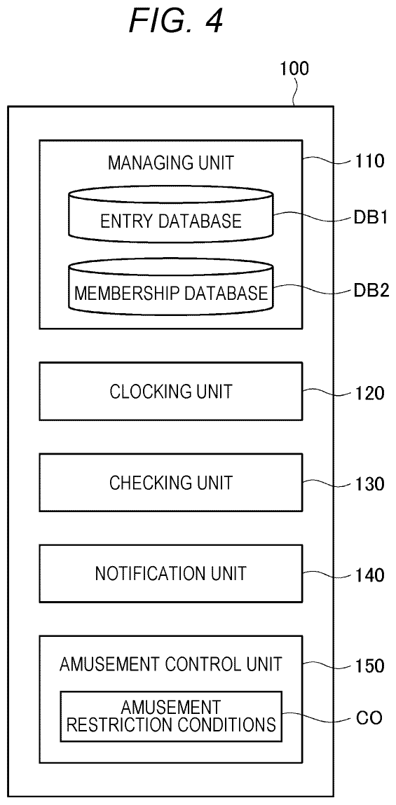

FIG. 4 is a block diagram illustrating the functional configuration implemented by the control device 11 in the managing server 100.

The managing server 100 includes a managing unit 110, a clocking unit 120, a checking unit 130, a notification unit 140, and an amusement control unit 150.

The managing unit 110 includes the entry database DB1 and the membership database DB2 and manages individual users who enter the casino facility. As already described, users who enter the facility are categorized into member users who have already been registered as members and non-member users who have not yet been registered as members. The detailed contents registered in the entry database DB1 and the membership database DB2 have already been described and are therefore omitted.

The clocking unit 120 has a timer function and a clock function (hereinafter collectively referred to as a “clocking function”) and measures the entry time at which each user enters the casino facility, the duration of stay thereof, the time of exit thereof, and the like. The entry time and the like that have been measured by the clocking unit 120 are successively updated and registered in the entry record data D1 on the corresponding user.

The checking unit 130 checks (compares) the entry record data D1 and the member data D2 against each other with reference to the entry database DB1 and the membership database DB2.

The notification unit 140 notifies users of various messages based on notification conditions previously set. The notification unit 140 notifies a user of each message by, for example, displaying each message on a display of the amusement machine 200 that the user uses to play a game or displaying each message on a display of a mobile terminal (e.g., smartphone) that the user has.

The amusement control unit 150 restricts game play by a user based on amusement restriction conditions CO previously set. As an example, the present embodiment is configured so that game play by a user is prohibited if the user is not a member user (i.e., is a non-member user) in accordance with the amusement restriction conditions Co.

In addition, even if a user is a member user, if the duration of stay in the casino facility has reached the time limit, game play by the user is prohibited. For example, upon detecting that a user is not a member user or that the duration of stay of a member user in the casino facility has reached the time limit, the amusement control unit 150 controls each of the amusement machines 200 in the casino facility so as to prohibit game play in accordance with the amusement restriction conditions CO. However, if the foregoing non-member user has thereafter become a member user, or if the foregoing member user has paid an additional entry fee, the amusement control unit 150 controls each of the amusement machines 200 so as to lift the prohibition of (to permit) game play in the casino facility.

<Example of Operations in System that Solve First Problem>

Next, a sequence of operations in the facility management system 1 is described with reference to the drawings.

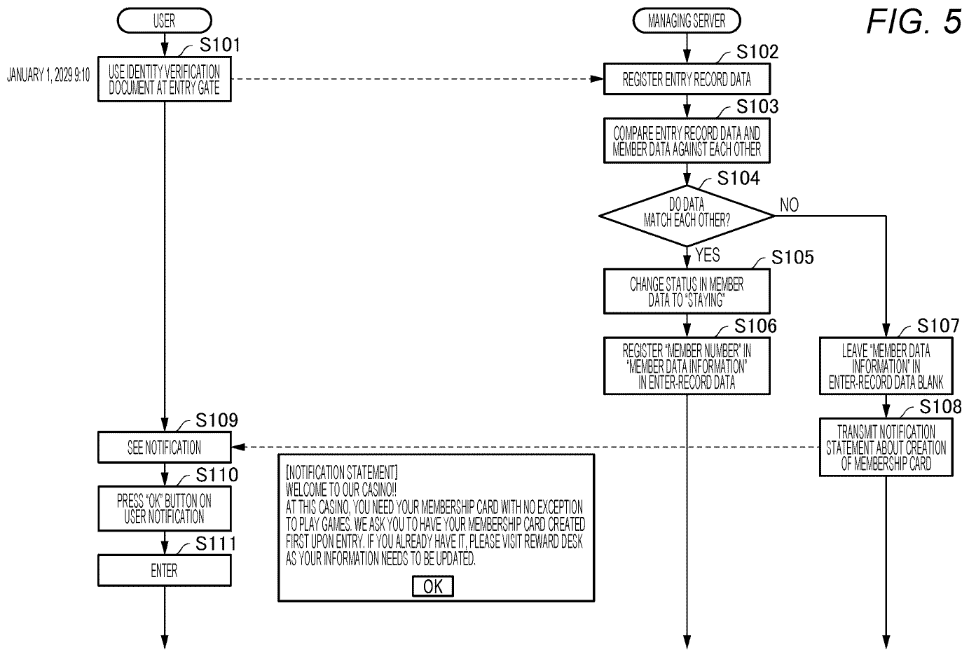

FIG. 5 is a sequence diagram illustrating a sequence of operations in the facility management system 1 that solve a first problem.

A user first holds an identity verification document over an entry gate (step S101). Upon acquiring, from the identity verification document, basic user information and other information that are necessary to manage matters such as the entry and exit of the user, the entry gate transmits the information to the managing server 100.

Upon receiving the basic user information from the entry gate, the managing server 100 generates entry record data D1 for the user based on the identity verification document presented of the user and registers the data in the entry database DB1. Specifically, the managing server 100 registers the entry record data D1, which includes an entry time, warning times, a time limit, times-of-entry limits, and a status (“Staying”) along with the basic user information such as a name, an address, a date of birth, and a gender that have been acquired from the identity verification document (step S102).

The managing server 100 refers to the entry database DB1 and the membership database DB2, checks (compares) the entry record data D1 with the member data D2 (step S103), and determines whether the two sets of data match each other (step S104). Upon confirming that the two sets of data match each other (YES in step S104), the managing server 100 registers “Staying” as the status in the member data D2, and registers, as member data information in the entry record data D1, a “member number” read from the member data (steps S105 and S106).

In contrast, upon determining that member data that matches the entry record data has not been registered (i.e., is not available) (NO in step S104), the managing server 100 notifies the user of a message (notification statement) without registering anything in the member number information in the entry record data D1, the message prompting the user to create a membership card (steps S107 and S108). Even when the user is one who has already created a membership card, the entry record data D1 and the member data D2 do not match each other in some cases, for example, if the user has failed to update information in the membership card (e.g., a change in address). In anticipation of such a case, the user may be notified of a creation/update message for creating a membership card or updating information as illustrated in a notification statement in FIG. 5. The user may also be notified of a message that login to the amusement machines 200 is not enabled.

Upon reading the notification statement via the entry gate (step S109), the user clicks the “OK” button on a display at the entry gate (step S110) and enters (step S111).

Staff in the casino facility (e.g., dealers, floor persons, and surveillance persons) may be enabled to regularly check whether the member data information has been registered in the entry record data D1 of each user through mobile terminals or terminals installed on the floor. For example, a user for which the member data information has not been registered in the entry record data D1 is not a member user, and the staff may ask the user a question such as whether there is any inconvenience. If there is no particular reason, the user may be monitored as a suspicious character.

### <Second Problem and Solution Thereto>

If, for example, a user has relocated and the address of a user has been changed (e.g., from Tokyo to Kanagawa) by the time of the present entry since the last time the user entered the casino facility, the address (e.g., Kanagawa) of the user acquired from the identity verification document may differ from the address (e.g., Tokyo) registered in the member data. If the user in such a case is permitted to play games without any concerns in the casino facility, various problems may occur when identity verification is needed for reasons such as anti-money laundering (AML).

In light of these circumstances, the present embodiment is directed to constructing a mechanism that makes it possible to prohibit a user from playing games if the user is not found (i.e., does not match data) when information on the user acquired from an identity verification document at the time of entry thereof into the casino facility is checked (compared) against the member data D2 registered in the membership database DB2.

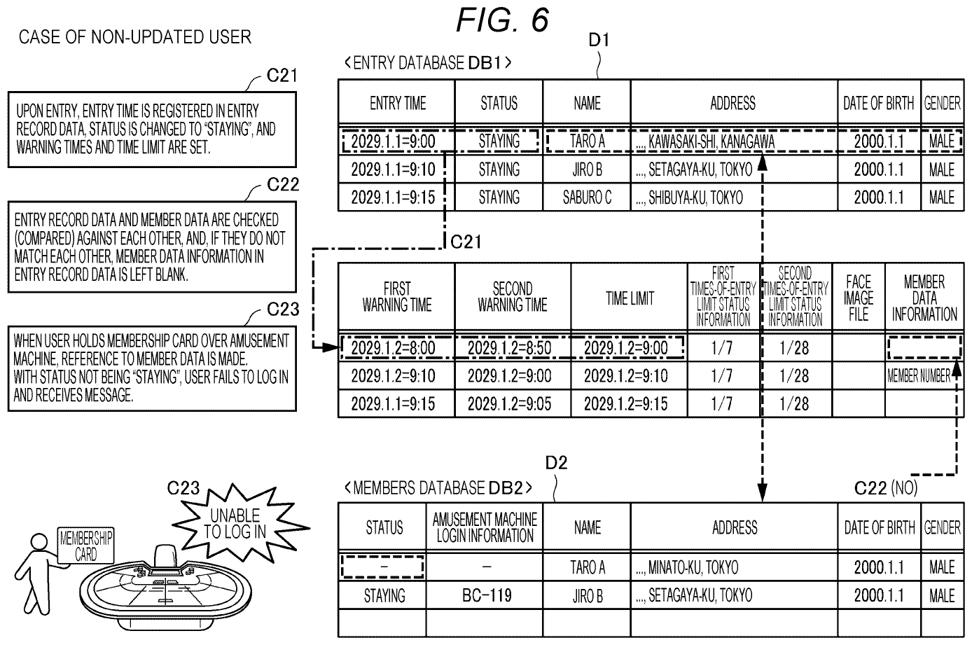

FIG. 6 illustrates a sequence of operations that are executed when a user (hereafter “non-updated user”) who has not updated the member data thereof even though the basic user information (e.g., the address) thereof has been changed enters the casino facility.

When a non-updated user presents an identity verification document at the entry gate, the managing server 100 generates entry record data D1 for the user based on the presented identity verification document of the user and registers the entry record data D1 in the entry database DB1. Specifically, the managing server 100 registers the piece of entry record data D1, which includes the entry time, warning times, time limit, times-of-entry limits, and status (“Staying”) along with the basic user information, which includes the address after the change (“ . . . , Kanagawa” in FIG. 6), from the identity verification document (C21).

The managing server 100 then checks (compares) the entry record data D1 against the member data D2 with reference to the entry database DB1 and the membership database DB2. In this case, the address of the user registered in the member data has not been updated and remains the same as the previous address (“ . . . , Tokyo” in FIG. 6), and the managing server 100 therefore determines that no matching member data has been registered. In this case, nothing is registered as the member data information in the entry record data D1, and nothing is registered as the status in the member data (C22).

The non-updated user then holds the membership card over one of the amusement machines 200 (e.g., a game table) in the casino facility, thereby making a request for login. The amusement machine 200 inquires the managing server 100 for the member data. The managing server 100 refers to the membership database DB2, thereby determining whether or not to permit the login. In this case, the status registered in the member data D2 on the non-updated user is not “Staying.” The managing server 100 therefore prohibits the user from logging in to the amusement machine 200 (the login is not enabled) and transmits a message prompting the user to update the member data (C23). The non-updated user understands that the user is not permitted to play games without updating the member data thereof via the amusement machine 200 or other means. In this case, the user may be notified of the very issue of prohibition of login to the amusement machine 200, or otherwise be directly notified of a message that the user is not enabled to log in to the amusement machine 200.

### <Example of Operations in System That Solve Second Problem>

Next, a sequence of operations in the facility management system 1 is described with reference to the drawings. The functional configuration and the like of the managing server are described above and therefore omitted.

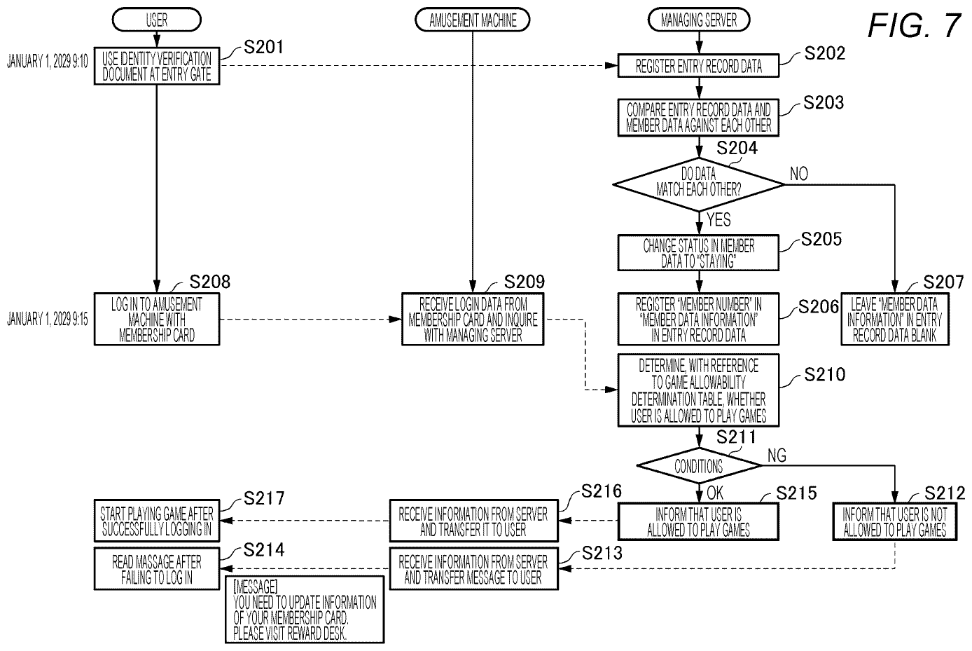

FIG. 7 is a sequence diagram illustrating a sequence of operations in the facility management system 1 that solve a second problem.

A user first holds an identity verification document over an entry gate (step S201). Upon acquiring, from the identity verification document, basic user information and other information that are necessary to manage matters such as the entry and exit of the user, the entry gate transmits the information to the managing server 100.

Upon receiving the basic user information from the entry gate, the managing server 100 registers entry record data D1 on the user in the entry database DB1.

Specifically, the managing server 100 registers the entry record data D1, which includes an entry time, warning times, a time limit, times-of-entry limits, and a status (“Staying”) along with the basic user information such as a name, an address, a date of birth, and a gender that have been acquired from the identity verification document (step S202).

The managing server 100 refers to the entry database DB1 and the membership database DB2, checks (compares) the entry record data D1 against the member data D2 (step S203), and determines whether the data matches each other (step S204). Upon confirming that the two sets of data match each other (YES in step S204), the managing server 100 registers “Staying” as the status in the member data D2, and registers, as member data information in the entry record data D1, a “member number” read from the member data (steps S205 and S206).

In contrast, upon determining that no matching data is among the registered member data (NO in step S203), which is because the address in the member data has not been updated even though the basic user information (e.g., the address) has been changed, for example, the managing server 100 registers nothing as the member data information in the entry record data D1 and nothing as the entry status in the member data (step S207).

Meanwhile, the user attempts to log in by holding the membership card over the amusement machine 200 (step S208). The membership card transmits login data (e.g., a user ID) to the amusement machine 200. Upon receiving the login data from the membership card, the amusement machine 200 inquires of the managing server 100 whether the user is allowed to log in (i.e., whether the user is allowed to play games) (step S209).

Upon receiving the inquiry, the managing server 100 refers to the game allowability determination table (not illustrated) that has been set to determine whether the user is allowed to play games (step 210). The game allowability determination table has, for example, three conditions for determining that the user is allowed to play games (see (1) to (3) below).
(1) The status is “Staying” in the member data.
(2) The time since entry (duration of stay) has not yet exceeded the time limit.
(3) The duration of stay has not exceeded the self-exclusion time (e.g., 15 hours since entry) set by the user in consideration of addiction prevention or the like.

Upon determining that the condition illustrated in (1) is not met (NO in step S211) because nothing has been registered as the status in the member data of the user in this case, the managing server 100 determines that the user is not allowed to play games. The managing server 100 then prohibits the user from logging in to the amusement machine 200 to which the user has attempted to log in, and notifies the amusement machine 200 of a message prompting the user to update the member data (step S212).

The amusement machine 200, for example, by displaying the message from the managing server 100 on the display, prohibits the user from logging in to the amusement machine 200 and notifies the user of the message prompting the user to update the member data (step S213). The user reads the message via the amusement machine 200 (step S214).

In contract, upon determining in step S211 that all conditions (1) through (3) are met (YES in step S211), the managing server 100 determines that the user is allowed to play games. The managing server 100 then notifies the amusement machine 200 to which the user has attempted to log in that the user is allowed to log in to the amusement machine 200 (step S215).

The amusement machine 200, for example, by displaying a message from the managing server 100 on the display, notifies the user that the user is allowed to log in to the amusement machine 200 (step S216). Upon reading the message via the amusement machine 200, the user performs a certain operation and starts playing a game (step S217).

### <Third Problem and Solution Thereto>

Casino facilities may need to collect an additional entry fee based on the time since entry, thus facing an urgent need to accurately manage the time since each user entered (duration of stay) and ensure that users who have entered the facilities are accurately aware of the durations of their stay.

In light of these circumstances, a mechanism that ensures compliance with laws and regulations is constructed by strictly managing the entry times, the time limits for stay, and the like of users in addition to checking (comparing), against the member data D2 registered in the membership database DB2, information on the users acquired from identity verification documents at the time of entry into a casino facility.

### <Examples of Operations in System That Solve Third Problem>

Next, a sequence of operations in the facility management system 1 is described with reference to the drawings. The functional configuration and the like of the managing server are described above and therefore omitted. The following description assumes that a member user (hereinafter simply referred to as “user”) enters a casino facility.

### First Example of Operations

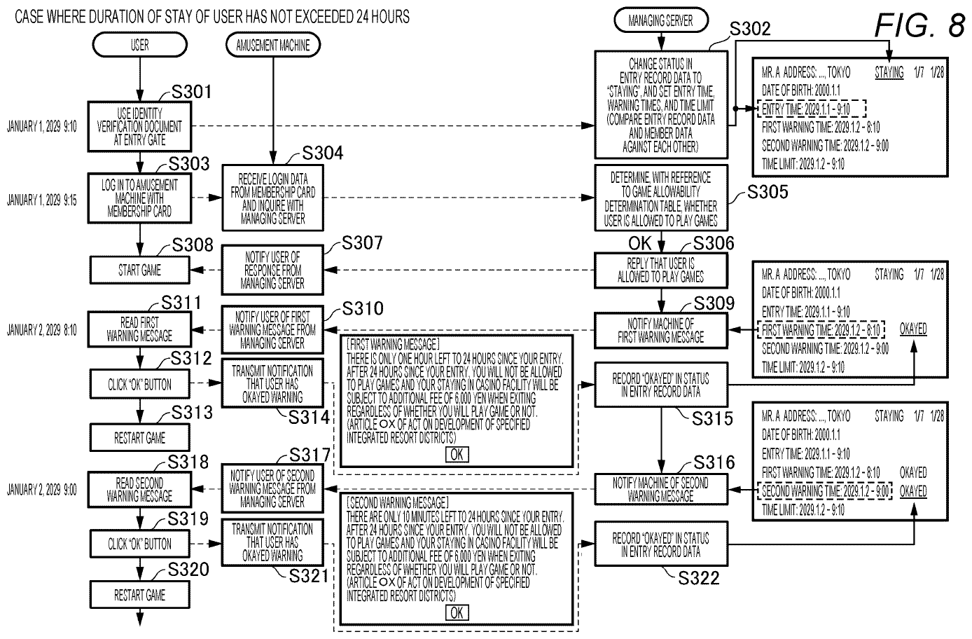

FIG. 8 is a sequence diagram illustrating a first example of operations in the facility management system 1 that solve the third problem.

As the first example of operations, a sequence of operations for a period until the duration of stay of the user exceeds 24 hours is described.

The user first holds an identity verification document over an entry gate (step S301). Upon acquiring, from the identity verification document, basic user information and other information that are necessary to manage matters such as the entry and exit of the user, the entry gate transmits the information to the managing server 100.

The managing server 100 registers entry record data D1, which includes an entry time, warning times, a time limit, times-of-entry limits, and a status (“Staying”) along with the basic user information such as a name, an address, a date of birth, and a gender that have been acquired from the identity verification document (step S302).

Furthermore, the managing server 100 refers to the entry database DB1 and the membership database DB2, checks (compares) the entry record data D1 against the member data D2 (step S302), and determines whether the data matches each other. In this case, the user is a valid member user. Thus, determining that the data match each other, the managing server 100 registers “Staying” as the status in the member data D2 and registers, as member number information in the entry record data D1, a “member number” read from the member data.

Thereafter, the user attempts to log in by holding a membership card over one of the amusement machines 200 (step S303). The membership card transmits login data (e.g., a user ID) to the amusement machine 200. Upon receiving the login data from the membership card, the amusement machine 200 inquires of the managing server 100 whether the user is allowed to play games (step S304).

Upon receiving the inquiry, the managing server 100 refers to the game allowability determination table (not illustrated) that has been set to determine whether the user is allowed to play games (step S305). As described above, for example, three conditions for determining that the user is allowed to play games are set in the game allowability determination table (see (1) to (3) below).
(1) The status is “Staying” in the member data.
(2) The time since entry (duration of stay) has not yet exceeded the time limit.
(3) The duration of stay has not exceeded the self-exclusion time (e.g., 15 hours since entry) set by the user in consideration of addiction prevention or the like.

Upon determining that the user is allowed to play games, the managing server 100 replies to the amusement machine 200 that the user is allowed to play games (step S306). The amusement machine 200, for example, by presenting a reply on the display or the like, notifies the user that the user is allowed to play games (step S307). Upon confirming that the user is allowed to play games via the amusement machine 200, the user starts playing a game (e.g., baccarat) using the amusement machine 200 (step S308).

Meanwhile, the managing server 100 measures the duration of stay of the user by using the clocking function. Upon detecting that the duration of stay of the user has reached a first warning time, the managing server 100 notifies the amusement machine 200 currently used by the user to play a game of a remaining time (the first warning time in this case) before the time limit and a first warning message that the user is about to be prohibited from playing games unless the user pays an additional entry fee (step S309). The amusement machine 200 notifies the user of the first warning message, for example, by displaying the first warning message on a display (step S310). Upon reading the first warning message via the amusement machine 200 (step S311), the user clicks the “OK” button displayed on the display (step S312) and restarts playing the game (step S313).

When the “OK” button is clicked by the user, a notification that the first warning message has been read (okayed) is transmitted to the managing server 100 via the amusement machine 200 (step S314).

Upon receiving the notification that the user has okayed the message, the managing server 100 adds and records a status indicating that the user has okayed the first warning message in the status in the entry record data D1 of the user (step S315).

Meanwhile, the managing server 100 continues measuring the duration of stay of the user. Upon detecting that the duration of stay of the user has exceeded the first warning time and reached a second warning time, the managing server 100 notifies the amusement machine 200 currently used by the user to play a game of a remaining time (the second warning time in this case) before the time limit and a second warning message that the user is about to be prohibited from playing games unless the user pays an additional entry fee (step S316). The amusement machine 200 notifies the user of the second warning message, for example, by displaying the second warning message on the display (step S317). Upon reading the second warning message via the amusement machine 200 (step S318), the user clicks the “OK” button displayed on the display to indicate that the warning message has been read (step S319) and restarts playing the game (step S320).

When the “OK” button is clicked by the user, a notification that the second warning message has been read (okayed) is transmitted to the managing server 100 via the amusement machine 200 (step S321).

Upon receiving the notification that the user has okayed the message, the managing server 100 adds and records a status indicating that the user has okayed the second warning message in the status in the entry record data D1 of the user (step S322).

In the first example of operations described above, no particular timing for displaying each message is mentioned, but for example, each message may be displayed at a timing that does not interfere with the progress of the game played by the user. As an example, each message may be displayed on the display of the amusement machine 200 when the user logs in before starting to play a game or finishes a game. In addition to having the user notified of each message via the amusement machine 200, staff members in the casino facility (e.g., dealers, floor persons, and surveillance persons) may be notified of each message. As an example, the managing server 100 notifies the terminal of each of the staff members in the casino facility of the same messages that the user is notified of. Preferably, the message may include the user ID or other information that identifies the user. Each staff member can, by reading the message displayed on the terminal thereof, immediately understand which user has been notified of which message (these applications can also be applied to each of the following examples of operations).

### Second Example of Operations

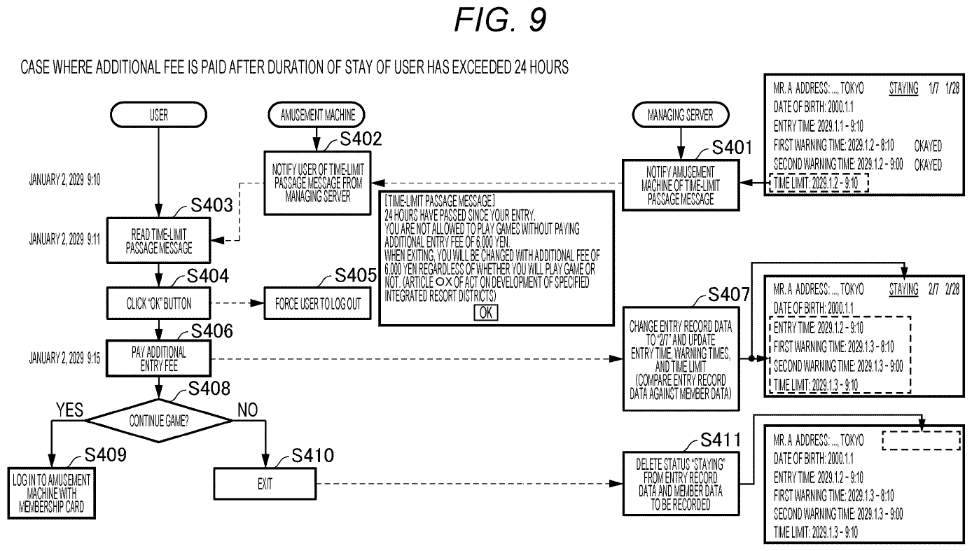

FIG. 9 is a sequence diagram illustrating a second example of operations in the facility management system 1 that solves the third problem.

As the second example of operations, a sequence of operations in a case where additional entry fee is paid after the duration of stay of the user exceeds 24 hours is described. The following description assumes that the user has already been notified of the second warning message.

Upon detecting that the duration of stay of the user has exceeded the second warning time and reached the time limit, the managing server 100 notifies the amusement machine 200 currently used by the user to play a game that the time limit has been passed and of a time-limit passage message that the user is prohibited from playing games unless the user pays an additional entry fee (step S401).

The amusement machine 200 notifies the user of the time-limit passage message, for example, by displaying the time-limit passage message on the display (step S402).

Upon reading the time-limit passage message via the amusement machine 200 (step S403), for example, after finishing a game, the user clicks the “OK” button displayed on the display to indicate that the time-limit passage message has been read (step S404). When this operation is performed, a notification that the time-limit passage message has been read is transmitted to the managing server 100 via the amusement machine 200. In response, the managing server 100 transmits a prohibition command to the amusement machine 200 to prohibit the user from playing games. In accordance with the prohibition command received from the managing server 100, the amusement machine 200 forces the user to log out (step S405).

Meanwhile, the user pays the additional entry fee (step S406). The additional entry fee can be paid by use of, for example, an entry fee payment machine, a mobile terminal owned by the user, or a cashier window. When the additional entry fee is paid by the user, the managing server 100 changes the first times-of-entry limit status information in the entry record data D1 of the user to “2/7” and updates the entry time, warning times, and time limit in the entry record data D1 of the user in accordance with the entry time for the second time of entry (Step S407). Note that the second entry time is rolled back to the time at which 24 hours passed since the first entry time, not the time at which the additional entry fee is paid.

Furthermore, the managing server 100 refers to the entry database DB1 and the membership database DB2 and checks (compares) the entry record data D1 against the member data D2. The operations after the comparison are already described above and are therefore omitted.

Meanwhile, the user decides whether or not to continue playing games (step S408). If the user continues playing games (YES in step S408), the user holds the membership card thereof over one of the amusement machines 200 and attempts to log in (step S409). In contrast, if the user does not continue playing games (NO in step S408), the user exits through the entry gate (step S410). The entry gate notifies the managing server 100 that the user has exited. Upon receiving a notification that the user has exited, the managing server 100 accesses the entry database DB1 and the membership database DB2, and deletes the status of “Staying” from the entry record data D1 and the member data D2 to be recorded (step S411).

### Third Example of Operations

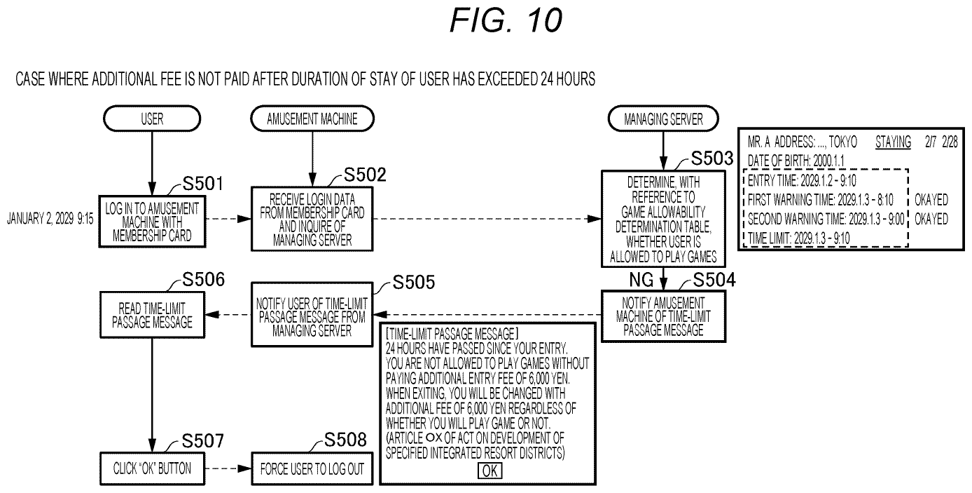

FIG. 10 is a sequence diagram illustrating a third example of operations in the facility management system 1 that solves the third problem.

As the third example of operations, a sequence of operations in a case where additional entry fee is not paid after the duration of stay of a user exceeds 24 hours is described. The following description assumes that the user has already been notified of the second warning message.

The user attempts to log in by holding the membership card over the amusement machine 200 (step S501). The membership card transmits login data (e.g., a user ID) to the amusement machine 200. Upon receiving the login data from the membership card, the amusement machine 200 inquires of the managing server 100 whether the user is allowed to play games (step S502).

Upon receiving the inquiry, the managing server 100 refers to the game allowability determination table (not illustrated) that has been set to determine whether the user is allowed to play games (step S503). As described above, three conditions for determining that the user is allowed to play games are set in the game allowability determination table (see (1) to (3) below).
(1) The status is “Staying” in the member data.
(2) The time since entry (duration of stay) has not yet exceeded the time limit.
(3) The duration of stay has not exceeded the self-exclusion time (e.g., 15 hours since entry) set by the user in consideration of addiction prevention or the like.

In this case, the condition described in (2) is not met because the duration of stay of the user has exceeded the time limit. The managing server 100 therefore determines that the user is not allowed to play games. The managing server 100 then notifies the amusement machine 200 to which the user has attempted to log in that the time limit has been passed and of a time-limit passage message that the user is prohibited from playing games unless the user pays an additional entry fee (step 504).

The amusement machine 200 notifies the user of the time-limit passage message, for example, by displaying the time-limit passage message on the display (step S505).

Upon reading the time-limit passage message via the amusement machine 200 (step S506), the user clicks the “OK” button displayed on the display (step S507). When this operation is performed, a notification that the time-limit passage message has been read is transmitted to the managing server 100 via the amusement machine 200. In response, the managing server 100 transmits a prohibition command to the amusement machine 200 to prohibit the user from playing games. In accordance with the prohibition command received from the managing server 100, the amusement machine 200 forces the user to log out (step S508).

### Fourth Example of Operations

As the fourth example of operations, a sequence of operations in a case where a user is forced to leave (exit) the casino facility in accordance with each of the following forced-exit conditions is described.

### <<First Forced-Exit Condition>>

The number of times of entry and the like for the past seven days has reached a first times-of-entry limit (e.g., 3 times), and a predetermined period of time (e.g., slightly less than 24 hours since the most recent entry) has passed.

### <<Second Forced-Exit Condition>>

The number of times of entry and the like for the past 28 days has reached a second times-of-entry limit (e.g., 10 times), and a predetermined period of time (e.g., slightly less than 24 hours since the most recent entry) has passed.

The “number of times of entry and the like” includes the number of times the user has entered the facility upon payment of an entry fee and the number of times the user has been allowed to enter the facility upon payment of an additional entry fee. Each of the forced-exit conditions is not limited to the above substances, but can be set as any conditions that ensure compliance with various laws and regulations (e.g., the Act on Development of Specified Integrated Resort Districts) related to casino facilities. Furthermore, although the number of forced-exit conditions is two in this embodiment, any number of forced-exit conditions may be set.

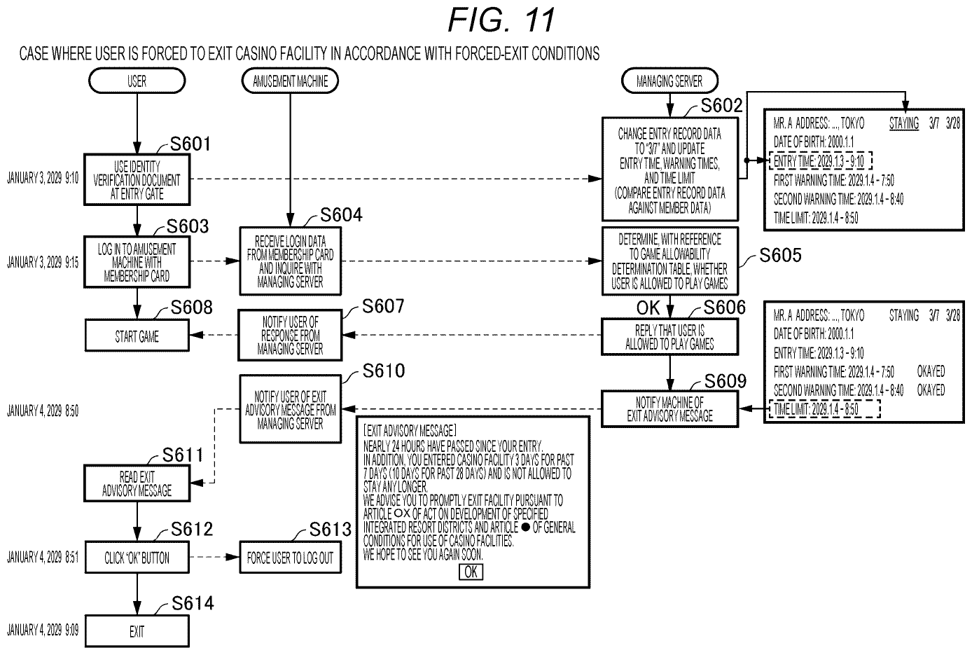

FIG. 11 is a sequence diagram illustrating the fourth example of operations in the facility management system 1 that solves the third problem. The following description assumes that the number of times of entry and the like of the user for the past seven days is two.

The user first holds an identity verification document over an entry gate (step S601). Upon acquiring, from the identity verification document, basic user information and other information that are necessary to manage matters such as the entry and exit of the user, the entry gate transmits the information to the managing server 100.

The managing server 100 registers entry record data D1, which includes an entry time, warning times, a time limit, times-of-entry limits, and a status (“Staying”) along with the basic user information such as a name, an address, a date of birth, and a gender that have been acquired from the identity verification document.

Specifically, in accordance with the current entry, the managing server 100 changes the first times-of-entry limit status information in the entry record data D1 of the user to “3/7” and updates the entry time, warning times, and time limit in the entry record data D1 of the user (Step S602). When the first times-of-entry limit status information has become “3/7” or the second times-of-entry limit status information has become “10/28”, the limits of the warning times and time limit are set to 20 minutes before the previously set times. As an example, the first warning time is set to 22 hours and 40 minutes after the entry time instead of 23 hours after the entry time, and the time limit is set to 23 hours and 40 minutes after the entry time instead of 24 hours after the entry time. However, the limits of the warning times and time limit may be set in any manner.

Furthermore, the managing server 100 refers to the entry database DB1 and the membership database DB2 and checks (compares) the entry record data D1 against the member data D2. The operations after the comparison are already described above and are therefore omitted.

Meanwhile, the user attempts to log in by holding the membership card over the amusement machine 200 (step S603). The membership card transmits login data (e.g., a user ID) to the amusement machine 200. Upon receiving the login data from the membership card, the amusement machine 200 inquires of the managing server 100 whether the user is allowed to play games (step S604).

Upon receiving the inquiry, the managing server 100 refers to the game allowability determination table (not illustrated) that has been set to determine whether the user is allowed to play games (step S605). As described above, three conditions for determining that the user is allowed to play games are set in the game allowability determination table (see (1) to (3) below).
(1) The status is “Staying” in the member data.
(2) The time since entry (duration of stay) has not yet exceeded the time limit.
(3) The duration of stay has not exceeded the self-exclusion time (e.g., 15 hours since entry) set by the user in consideration of addiction prevention or the like.

Upon determining that the user is allowed to play games, the managing server 100 determines replies to the amusement machine 200 that the user is allowed to play games (step S606). The amusement machine 200, for example, by presenting a reply on the display or the like, notifies the user that the user is allowed to play games (step S607). Upon confirming that the user is allowed to play games via the amusement machine 200, the user starts playing a game (e.g., baccarat) using the amusement machine 200 (step S608).

Thereafter, the user is notified of the first and second warning messages according to the duration of stay of the user, and, upon detecting that the duration of stay of the user has reached the time limit, the managing server 100 determines that the first forced-exit condition is met because the number of times of entry and the like of the user for the past seven days has reached 3 times and the time limit has been reached. Upon determining that the first forced-exit condition is met, the managing server 100 notifies the amusement machine 200 currently used by the user to play a game that the time limit has been reached and of an exit advisory message that the user should exit the casino facility promptly (Step S609).

The amusement machine 200 notifies the user of the exit advisory message, for example, by displaying the exit advisory message on the display (step S610). Upon reading the exit advisory message via the amusement machine 200 (step S611), the user clicks the “OK” button displayed on the display (step S612). When this operation is performed, a notification that the exit advisory message has been read is transmitted to the managing server 100 via the amusement machine 200. In response, the managing server 100 transmits a prohibition command to the amusement machine 200 to prohibit the user from playing games. In accordance with the prohibition command received from the managing server 100, the amusement machine 200 forces the user to log out (step S613). Meanwhile, having read an exit message, the user promptly exits the casino facility (step S614).

As described above, according to the facility management system that solves the third issue, when the duration of stay in the casino facility approaches the time limit, the user is notified of the remaining time before the time limit and a warning message that the user is about to be prohibited from playing games unless the user pays an additional entry fee. This allows the user to accurately grasp information such as the remaining time for which the user is allowed to stay (see the first example of operations).

When the duration of stay of the user reaches the time limit, the user is notified of the time-limit passage message, and the user is prohibited from playing games unless the user pays an additional entry fee. Therefore, it is possible to prevent users from illegally staying in the casino facility and continuing to play games (see the second and the third examples of operations).

Furthermore, if the stay of the user in the casino facility meets any of the forced-exit conditions, the user is notified of the exit advisory message that the user should exit the casino facility promptly and is prohibited from playing games. This allows the user to comply with laws and regulations and to be prompted to exit the facility promptly (see the fourth example of operations).

### <Modification of Facility Management System That Solves Third Problem>

In the first through fourth examples of operations described above, the users are notified of various messages via the amusement machines 200. In fifth and sixth examples of operations described below, the users are notified of various messages via mobile terminals carried by the users.

A mobile terminal is configured of, for example, a mobile phone, a smartphone, a tablet terminal, a wearable terminal, or the like and has a processor, a storage device, a communication device, an input device, an output device, and an antenna. Various software, browsers, data, and the like necessary to use the present system 1 have been stored in the storage device.

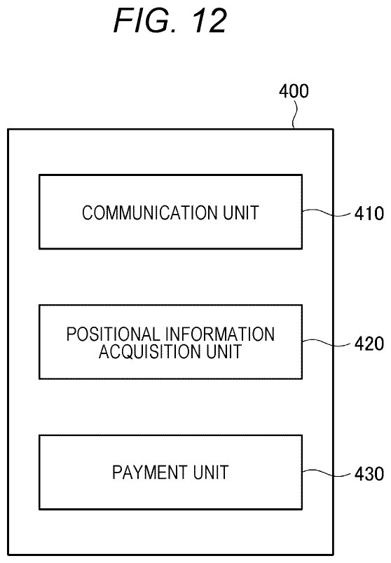

FIG. 12 is a block diagram illustrating the functional configuration of a mobile terminal 400.

The mobile terminal 400 includes a communication unit 410, a positional information acquisition unit 420, and a payment unit 430. The communication unit 410, the positional information acquisition unit 420, and the payment unit 430 are implemented by the processor and the communication device executing a program stored in the storage device.

The communication unit 410 communicates with the managing server 100, other terminals, and the like via the communication network N.

The positional information acquisition unit 420 uses, for example, GPS and wireless access points to acquire positional information on the mobile terminal 400. Positional information acquired by the positional information acquisition unit 420 is regularly or irregularly transmitted by the communication unit 410 to the managing server 100.

The payment unit 430 performs payment of entry fees (including additional entry fees) and the like according to operations input by a user. When the payment of the entry fee is performed by the payment unit 430, the communication unit 410 transmits information indicating that the entry fee has been paid (hereinafter referred to as “entry fee payment information”) to the managing server 100.

### Fifth Example of Operations

As the fifth example of operations, a sequence of operations in a case where a user is notified of a warning message via a mobile terminal of the user is described.

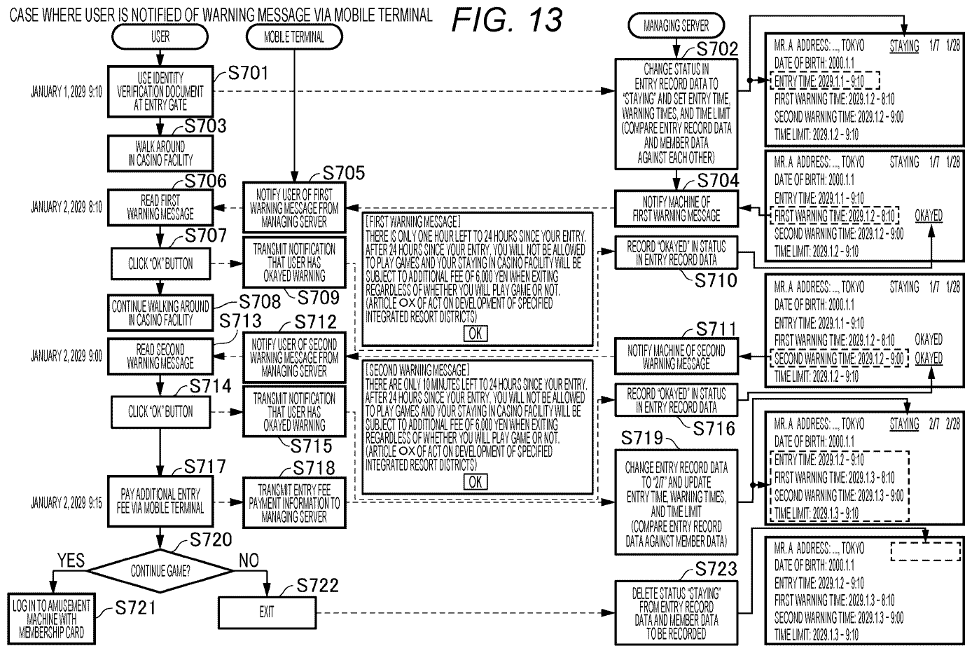

FIG. 13 is a sequence diagram illustrating the fifth example of operations in the facility management system 1 that solves the third problem. The following description focuses on the differences thereof with the first and the second examples of operations.

The user first holds an identity verification document over an entry gate (step S701). Upon acquiring, from the identity verification document, basic user information and other information that are necessary to manage matters such as the entry and exit of the user, the entry gate transmits the information to the managing server 100.

The managing server 100 registers entry record data D1, which includes an entry time, warning times, a time limit, times-of-entry limits, and a status (“Staying”) along with the basic user information such as a name, an address, a date of birth, and a gender that have been acquired from the identity verification document (step S702).

The managing server 100 then checks (compares) the entry record data D1 against the member data D2 with reference to the entry database DB1 and the membership database DB2 (step S702). The operations after the comparison are already described above and are therefore omitted.

Meanwhile, the user walks around in the casino facility (step S703). Meanwhile, the managing server 100 starts measuring the duration of stay of the user. Upon detecting that the duration of stay of the user has reached the first warning time, the managing server 100 notifies the mobile terminal 400 of the user of a remaining time (the first warning time in this case) before the time limit by using positional information regularly or irregularly transmitted from the mobile terminal 400 of the user and the first warning message that the user is about to be prohibited from playing games unless the user pays an additional entry fee (step S704).

The mobile terminal 400 notifies the user of the first warning message, for example, by displaying the first warning message on a display (step S705). Upon reading the first warning message via the mobile terminal 400 (step S706), the user clicks the “OK” button displayed on the display (step S707) and continues walking around in the casino facility (step S708).

When the “OK” button is clicked by the user, a notification that the first warning message has been read (okayed) is transmitted to the managing server 100 via the mobile terminal 400 (step S709).

Upon receiving the notification that the user has okayed the message, the managing server 100 adds and records a status indicating that the user has okayed the first warning message in the status in the entry record data D1 of the user (step S710).

The managing server 100 continues measuring the duration of stay of the user. Upon detecting that the duration of stay of the user has exceeded the first warning time and reached the second warning time, the managing server 100 notifies the mobile terminal 400 of the user of a remaining time (the second warning time in this case) before the time limit and the second warning message that the user is about to be prohibited from playing games unless the user pays an additional entry fee (step S711). The mobile terminal 400 notifies the user of the second warning message, for example, by displaying the second warning message on the display (step S712). Upon reading the second warning message via the mobile terminal 400 (step S713), the user clicks the “OK” button displayed on the display to indicate that the second warning message has been read (step S714).

When the “OK” button is clicked by the user, a notification that the second warning message has been read (okayed) is transmitted to the managing server 100 via the mobile terminal 400 (step S715).

Upon receiving the notification that the user has okayed the message, the managing server 100 adds and records a status indicating that the user has okayed the second warning message under the status in the entry record data D1 of the user (step S716).

Meanwhile, the user pays the additional entry fee using the mobile terminal 400 (step S717). The mobile terminal 400 transmits, to the managing server 100, entry fee payment information indicating that the additional entry fee has been paid (step S718). Upon receiving the entry fee payment information from the mobile terminal 400, the managing server 100 changes first upper-limit times-of-entry information in the entry record data D1 of the user to “2/7” and updates the entry time, warning times, and time limit in the entry record data D1 of the user according to the entry time for the second time of entry (step S719). Note that the second entry time is rolled back to the time at which 24 hours passed since the first entry time, not the time at which the additional entry fee is paid.

The user decides whether or not to continue playing games (step S720). If the user continues playing games (YES in step S720), the user holds the membership card thereof over one of the amusement machines 200 and attempts to log in (step S721). In contrast, if the user does not continue playing games (NO in step S720), the user exits through the entry gate (step S722). The entry gate notifies the managing server 100 that the user has exited. Upon receiving a notification that the user has exited, the managing server 100 accesses the entry database DB1 and the membership database DB2, and deletes the status of “Staying” from the entry record data D1 and the member data D2 to be recorded (step S723).

### Sixth Example of Operations

As the sixth example of operations, a sequence of operations in a case where a mobile terminal of a user is used to force a user to exit the casino facility is described. The forced-exit conditions and assumptions are the same as those in the fourth example of operations described above, the following description focuses on the differences thereof with the fourth example of operations.

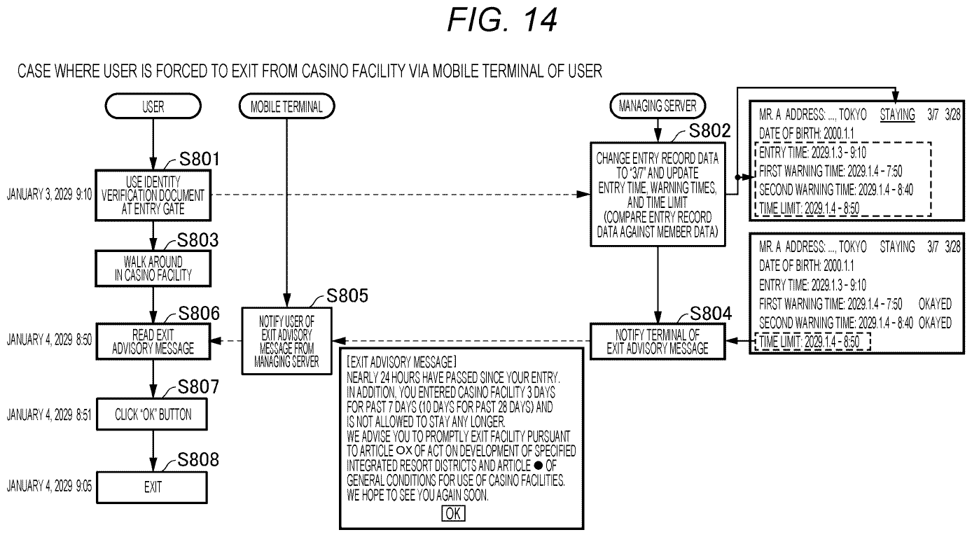

FIG. 14 is a sequence diagram illustrating the sixth example of operations in the facility management system 1 that solves the third problem.

The user first holds an identity verification document over an entry gate (step S801). Upon acquiring, from the identity verification document, basic user information and other information that are necessary to manage matters such as the entry and exit of the user, the entry gate transmits the information to the managing server 100.

The managing server 100 registers entry record data D1, which includes an entry time, warning times, a time limit, times-of-entry limits, and a status (“Staying”) along with the basic user information such as a name, an address, a date of birth, and a gender that have been acquired from the identity verification document.

Specifically, in accordance with the current entry, the managing server 100 changes the first times-of-entry limit status information in the entry record data D1 of the user to “3/7” and updates the entry time, warning times, and time limit in the entry record data D1 of the user (Step S802).

As in the fourth example of operations, upon detecting that the number of times of entry into the casino facility or the like of the user has reached the first upper limit (here, three times) or the second upper limit (here, ten times), the managing server 100 sets the limits of the warning times and time limit to 20 minutes before those originally set.

The user walks around in the casino facility (step S803). Meanwhile, the managing server 100 starts measuring the duration of stay of the user. Thereafter, the user is notified of the first and second warning messages according to the duration of stay of the user, and, upon detecting that the duration of stay of the user has reached the time limit, the managing server 100 determines that the first forced-exit condition is met because the number of times of entry and the like of the user for the past seven days has reached 3 times and the time limit has been reached.

Upon determining that the first forced-exit condition is met, the managing server 100, by using positional information regularly or irregularly transmitted from the mobile terminal 400 of the user, notifies the mobile terminal 400 of the user that the time limit has been reached and of an exit advisory message that the user should exit the casino facility promptly (Step S804). The mobile terminal 400 notifies the user of the exit advisory message, for example, by displaying the exit advisory message on its display or by other means (step S805).

Upon reading the exit advisory message via the mobile terminal 400 (step S806), the user clicks the “OK” button displayed on the display (step S807). Having read the exit advisory message, the user promptly exits the casino facility (step S808).

As described above, according to the facility management system according to the modification, the user is appropriately notified of each message by using the positional information of the mobile terminal carried by the user. This ensures that, even when a user is not playing a game in the casino facility, the user can be prompted to recognize each message and to comply with laws and regulation.

### REFERENCE SIGNS LIST

1 Facility management system
100 Managing server
11 Control device
12 Storage device
110 Managing unit
120 Clocking unit
130 Checking unit
140 Notification unit
150 Amusement control unit
DB1 Entry database
DB2 Membership database
D1 Entry record data
D2 Member data
CO Amusement restriction condition
200 Amusement machine
400 Mobile terminal
410 Communication unit
420 Positional information acquisition unit
430 Payment unit

1. A managing device configured to manage entry into an amusement facility, the managing device comprising:
a clocking unit configured to measure a duration of stay of a user who has entered the amusement facility; and
a notification unit configured to notify the user, before the duration of stay reaches a time limit, that a game played by use of an amusement machine in the amusement facility is about to be restricted when the duration of stay exceeds the time limit.

2. The managing device according to claim 1, wherein the notification unit notifies the user when the game is not being played.

3. The managing device according to claim wherein the notification unit notifies the user via the amusement machine before a game is started on the amusement machine or after a game is finished on the amusement machine.

4. The managing device according to claim wherein the notification unit notifies the user via a mobile terminal of the user.

5. The managing device according to claim further comprising an amusement control unit configured to restrict a game played by the user by use of the amusement machine when the duration of stay exceeds the time limit.

6. The managing device according to claim 5, wherein the amusement control unit lifts the restricting of the game when the user performs a certain operation after the game is restricted.

7. The managing device according to claim 6, wherein
the certain operation is payment of an additional entry fee, and
the restricting of the game is to prohibit the game from being played.

8. The managing device according to claim 5, wherein, when the user meets a forced-exit condition that has been set, the amusement control unit restricts a game played by the user by use of the amusement machine, and the notification unit notifies the user that the user needs to exit the amusement facility.

9. The managing device according to claim 8, wherein the forced-exit condition is met when the user has performed a certain operation at least a certain number of times within a certain period and the duration of stay has exceeded a certain period of time.

10. A program causing a computer that manages entry into an amusement facility to execute the steps of:
measuring a duration of stay of a user who has entered the amusement facility; and
notifying the user, before the duration of stay reaches a time limit, that a game played by use of an amusement machine in the amusement facility is about to be restricted when the duration of stay exceeds the time limit.

11. A managing method for an amusement facility, the amusement facility being executed by a computer, the managing method comprising the steps of:
measuring a duration of stay of a user who has entered the amusement facility; and
notifying the user, before the duration of stay reaches a time limit, that a game played by use of an amusement machine in the amusement facility is about to be restricted when the duration of stay exceeds the time limit.
